(19) United States
(12) Patent Application Publication
(10) Pub. No.: US 2014/0337915 A1
(43) Pub. Date: Nov. 13, 2014

(54) System And Method For Creating Unique Digital Content Compilations

(71) Applicants: Richard Daniel Kanee, Toronto (CA); Michael John D'Agnillo, Flesherton (CA); William Gregory Keenan, Toronto (CA); Jason Garett Hatcher, Toronto (CA)

(72) Inventors: Richard Daniel Kanee, Toronto (CA); Michael John D'Agnillo, Flesherton (CA); William Gregory Keenan, Toronto (CA); Jason Garett Hatcher, Toronto (CA)

(73) Assignee: NAAVON BLAZE LP, Kanata, ON (CA)

(21) Appl. No.: 14/239,033

(22) PCT Filed: Aug. 15, 2012
(86) PCT No.: PCT/CA2012/000759

§ 371 Date: Apr. 10, 2014

Related U.S. Application Data
(60) Provisional application No. 61/523,636, filed on Aug. 15, 2011.

(51) Int. Cl. G06F 21/10

(52) U.S. Cl. CPC G06F 21/10
USPC 726/1

(57) ABSTRACT

A computer network implemented system includes a server application linked to a computer server, wherein the server application and the computer server are operable to enable an Internet platform that enables one or more administrative users to select digital media content items from one or more content libraries to form the digital merchandise compilations, associate one or more rules related to the consumption of the digital merchandise compilations, including the rights of users or groups of users to access, retrieve, trade, transfer or otherwise use the digital merchandise compilations, or components thereof (“consumption attributes”), and enforce the one or more consumption attributes regardless of the users or groups of users, or network-connected device(s) associated with such user or groups of users. Each digital merchandise compilation constitutes a unique media object, where the actions of the users relative to the media object is defined by the consumption attributes.

### CROSS REFERENCE TO RELATED APPLICATIONS

This application is a U.S. national stage of International Application No. PCT/CA2012/000759, filed Aug. 15, 2012, which claims priority to U.S. Provisional Patent Application Ser. No. 61/523,636, filed Aug. 15, 2011, each of which are incorporated herein by reference in their entirety.

### FIELD OF THE INVENTION

The present invention relates generally to computer systems and more specifically to computer implemented methods and systems for creation of digital content compilations.

### BACKGROUND OF THE INVENTION

Sale/distribution of information objects has become widespread. Their sale/distribution has been made highly efficient, and accessibility thereto has expanded, through digital distribution technologies. Sales of music in the form of downloads of musical files, for example through the iTunes™ and other Internet platforms has been growing quickly. Similarly, the sale of e-books has been increasing rapidly, driven by several factors, mainly the market adoption of several devices specifically designed for the viewing of e-books, such as the KINDLE™ by Amazon, iPad™ KOBO™ or the SONY READER™.

While electronic distribution of music, books, and other media objects is very convenient, electronic copies of media assets tack a number of attributes of physical media assets such as print books or music albums. Physical media assets may be associated with unique or rare attributes including provenance, scarcity, age, dedications and other distinctive markings or their physical condition. These attributes tend to make particular physical media assets to be more sought after than others, or enable emotional attachments to be built between one or more individuals and one or more media objects. The emotional attachments that can develop between an individual and certain articles can make collectors of individuals. Collectors tend to buy more articles that they collect. Collecting articles is a popular diversion, and collectors with common interests often organize into communities. Collection of articles tends to increase the demand for and perceived value of articles, especially classes of articles with rare attributes or attributes that are of interest to particular collectors or groups of collectors. In addition, there is a concept of “subjective value” of articles, which is referenced in academic literature, and which refers to the perceived value of an article, Ownership, and the rights normally assigned to ownership, such as the potential right of gifting, transfer, and sharing with others, has been established to enhance “subjective value”.

There is a need for a method and system that can impart on digital media assets or Merchandise unique or rare attributes such as those described, or analogous to those described.

### SUMMARY OF THE INVENTION

In one aspect of the present invention, a computer network implemented system and method is provided, for enabling the selection of digital content items, and assembly of the selected digital content items to form digital content compilations that constitute a new digital media object. The digital content compilations include or are linked to programming that enables the compilations to be collectable and/or tradable as between two or more users who are part of a computer network implemented environment of the present invention.

In one aspect of the digital content compilations, each compilation constitutes a unique collectable or tradable media object. Each media object is associated with a history log and stored to a computer memory linked to one or more network connected servers, which is tracked, updated, and associated with the media object by the computer system. The history log enables the platform of the invention to track user behaviour associated with a particular platform user. Using the history log, the computer platform of the present invention, is operable to establish a novel and innovative digital media asset, namely one that has provenance, in the sense that this term is used in connection with collectible physical assets. In other words, the platform of the present invention is operable to create and link to digital media content, including digital media assets or digital content compilations, a digital provenance. The digital media compilation may be linked with certain rights (such as the right to access or distribute digital content, e.g. whether a song may be transferred, how many times a song may be listened to etc) or status for example “super fans” or “super users” may be given different rights, including different content consumption rights), it should be understood that rights and status may be affected by one or more user behaviour parameters that are tracked by operation of the history log.

The digital media content used to assemble the digital content compilations may include any manner of digital media content, including but not limited to audio, video and images, text, and/or game elements.

In a particular implementation of the present invention, the digital content compilations constitute a “deck” of digital trading cards, linked by the system to one another, and associated by the system to a history and defined relatedness, so as to present a unique tradable or collectable digital media object.

The computer system is operable to enable the digital media content compilations to be distributed or otherwise consumed through a client application designed to run on one or more internet platforms, or social media platforms, using any manner of network connected devices (including desktop computers, laptop computers, tablet computers, mobile devices, game consoles, and connected TVs). Distribution, or other consumption may include trading, gifting, sharing or use of the digital media content compilations in computer or mobile device enabled games, as explained in one or more examples below.

The computer network implemented system of the invention consists of an Internet platform that (i) enables one or more administrative users to select digital media content items from one or more content libraries to form the digital merchandise compilations, (ii) associates one or more rules related to the consumption of the digital merchandise compilations, including the rights of users or groups of users to access, retrieve, trade, transfer or otherwise use the digital merchandise compilations, or components thereof (“consumption attributes”), and (iii) creates a software client that enforces the one or more consumption attributes regardless of the users or groups of users, or device(s) associated with such user or groups of users, wherein each digital merchandise compilation constitutes a unique media object, where the actions of the users or group of users relative to the media object is defined by the consumption attributes.

In another implementation the computer system includes one, or more utilities that enable administrative users to define the relationship of each media object in relation to each other to form a collection of media objects. This system may take the form of a serialized list, chronological order or an explicit connection between multiple objects in a non-linear form. This may take the form of defining the relationship between certain content objects such that their combination may “unlock” a new content object or affect the properties of the associated objects.

A skilled reader will understand that the platform of the present invention is configured so that the computer network environment enabled by the present invention enforces the consumption attributes across the various interactions enabled by or in conjunction with the computer network environment, which in turn enables the unique and innovative user experience in connection with the digital media asserts created and supported by operation the platform of the invention.

The computer network implemented system, in a further aspect, establishes a log of actions of the user or group of users relative to the digital merchandise compilations, which is dynamically updated based on such actions to establish a unique history for the digital merchandise compilation based on such actions, and such history defines or adds to the unique characteristics of the digital merchandise compilations.

In a further aspect of the invention, the system may also enable the definition, and association with the digital merchandise compilations of one or more “super-attributes” or “change attributes”, or criteria that enable the alteration of the consumption attributes, by selected users (for example administrative users) or based on specific actions (such as use of the digital merchandise compilations in one or more games associate with the system, with specific game outcomes). Examples of possible super-attributes include age of the digital merchandise compilation, number of trades or games involving the digital merchandise compilation, or level of scarcity or relative scarcity of the digital merchandise compilation (based on one or more associated attributes, including for example the number of users in the system that possess digital merchandise compilations with the same attributes or similar attributes, possibly as compared to the number of users in the system that possible digital merchandise compilations with different attributes). The super-attributes may be understood as attributes associated by the system with the digital merchandise compilations that are impacted by one or more other attributes defined or tracked by the system. The super-attributes may also be understood as selected attributes that the system permits to be modified based on controlled circumstances.

In this respect, before explaining at least one embodiment of the invention in detail, it is to be understood that the invention is not limited in its application to the details of construction and to the arrangements of the components set forth in the following description or the examples provided therein, or illustrated in the drawings. The invention is capable of other embodiments and of being practiced and carried out in various ways. Also, it is to be understood that the phraseology and terminology employed herein are for the purpose of description and should not be regarded as limiting.

In one aspect of the invention a computer network implemented system for creating and disseminating unique digital media content compilations, is provided comprising:
at least one computer network connected computer server linked to a database, and a server application linked to the computer server, wherein the server application and the computer server implement one or more computer utilities that:
enable one or more administrative users to select digital media content items from one or more content libraries stored to the database and form therefrom digital media content compilations, and
enable the administrative users to select one or more rules related to the consumption of the digital media content compilations, including the rights of users or groups of users to access/retrieve and share, trade and/or transfer or otherwise use the digital merchandise compilations, or components thereof (“consumption attributes”);
wherein the computer server is configured to connect to one or more network connected devices to enable users to interact with or otherwise consume the digital media content compilations, in a way that enforces the one or more consumption attributes regardless of the users or groups of users, or network connected device(s) associated with such user or groups of users;
wherein each digital merchandise compilation constitutes a unique digital media object, where the actions of the users or group of users relative to the unique digital media object is defined by the consumption attributes.

In another aspect, a computer implemented method for creating and disseminating unique digital media content compilations is provided comprising: (A) one or more rights holders providing one or more digital media content items to a database linked to at least one server computer connected to the Internet; (B) one or more administrative users selecting a plurality of the digital media content items from which to initiate the server computer to create a digital media content compilation; (C) the administrative users selecting one or more rules related to the consumption of the digital media content compilation, including the rights of users or groups of users to access/retrieve and share, trade and/or transfer or otherwise use the digital media content compilations, or components thereof (“consumption attributes”); (D) enabling users from one or more network connected devices to interact with or otherwise consume the digital media content compilations, such that the server computer enforces the one or more consumption attributes regardless of the users or groups of users, or network connected device(s) associated with such user or groups of users, wherein each digital merchandise compilation constitutes a unique digital media object, where the actions of the users or group of users relative to the media object is defined by the consumption attributes.

### DESCRIPTION OF THE DRAWINGS

FIG. 1 illustrates a schematic diagram depicting one embodiment of the system of the present invention.

FIG. 2 is a workflow diagram that illustrates the method of the present invention, in one particular implementation of the invention.

FIG. 3 is a further system diagram illustrating the system of the present invention, in another aspect thereof, in this case showing some of the functions and resources of the content promotion utility of the present invention.

FIGS. 4a, 4b, 4c, 4d, 4e, 4f, 4g, 4h, and 4i illustrate appearance and functions of a possible digital merchandise compilations, created by operation of the present invention.

FIG. 5 illustrates a generic computer implementation of the present invention.

In the drawings, embodiments of the invention are illustrated by way of example. It is to be expressly understood that the description and drawings are only for the purpose of illustration and as an aid to understanding, and are not intended as a definition of the limits of the invention.

### DETAILED DESCRIPTION

In one aspect of the present invention, a computer network implemented system and computer network implemented method is provided, for enabling one or more users to select digital content items from a library associated with a server computer, and assemble of the selected digital content items, which initiates the server computer to reconfigure the digital content items to form digital content compilations that constitute a new digital media object. The digital content compilations include or are automatically linked to a server computer program that enables the compilations to be collectable and/or tradable as between two or more users who are part of a computer network implemented environment of the present invention.

In one aspect of the invention, the server computer program includes an authoring utility, or set of authoring utilities that may enable administrative users to assemble digital content items, and also digital content compilations including digital content items. The web presentment utility (16), including as further described below.

The digital media content used to assemble the digital content compilations may include any manner of digital media content, including but not limited to audio, video and images, text, and/or game elements.

In a particular implementation of the present invention, the digital content compilations may constitute a “deck” of digital trading cards, linked by the computer system of the present invention to one another, and associated by the computer system to a history and defined relatedness, so as to present a unique shareable, tradable and/or collectable digital media object. This constitutes a novel and innovative computer system, and also a novel and innovative digital media object. The conception of this computer system and digital media objects enables digital media content to be leveraged in ways that enables novel and highly engaging interactions between users, and between users and digital media content. These interactions enable for example publishers to promote content (such as a TV program) with in new and innovative ways that have met with considerable acceptance and consumer appeal. Persons skilled in the art have struggled with the need for enabling interactions and engagement with content, and new content promotion strategies, and using content in connection with marketing campaigns in ways that integrate with social media interactions more effectively. The present invention represents a significant technical contribution to and advancement of the understanding of computer implemented technologies for enabling user engagement with digital media content.

Moreover, a person skilled in the art did not understand how to marry the interest of users in collecting things, with the advantages of using digital technologies that generate digital media objects that are freely reproducible.

A further important insight is the opportunity to define interrelationships between digital media objects comprising a digital media collection, and further the specific technology mechanisms used to enable users (for example publishers) to configure digital content compilations in a flexible manner to address a range of promotional and other objectives, examples of which are provided below.

For example, the computer system is operable to enable the digital media content compilations to be distributed or otherwise consumed across one or more web or social media platforms, using any manner of network connected devices (including desktop computers, laptop computers, tablet computers, mobile devices, game consoles, and connected TVs). Distribution or other consumption may include trading, gifting, or use of the digital media content compilations in computer or mobile device enabled games, as explained in one or more examples below. Distribution may also constitute sharing, or making one user's personal media accessible to other network connected users, if this is permitted as part of the distribution rules associated with the particular digital media content compilation. Content publishers for example may use the computer platform of the present invention to leverage for example existing content, and their associated distribution rights, to configure digital content compilations that constitute a mix of digital content and associated permissions that unlock new value and engagement opportunities from existing content libraries.

The computer network implemented system of the invention may be implemented as an Internet connected computer platform that (i) enables one or more administrative users to select digital media content items from one or more content libraries to form the digital merchandise compilations, (ii) associates one or more rules related to the consumption of the digital merchandise compilations, including the rights of users or groups of users to access, retrieve, trade, transfer or otherwise use the digital merchandise compilations, or components thereof (“consumption attributes”), and (iii) enables one or more computer programs or Internet sites linked to the server computer of the present invention that enforce the one or more consumption attributes regardless of the users or groups of users, or network connected device(s) associated with such user or groups of users, wherein each digital merchandise compilation constitutes a unique media object, where the actions of the users or group of users relative to the media object is defined by the consumption attributes. It is important to understand that the platform of the present invention is configured so that the computer network environment enabled by the present invention enforces the consumption attributes across the various interactions enabled by or in conjunction with the computer network environment, which in turn enables unique and innovative user experiences in connection with the digital media asserts created and supported by operation of the platform of the invention.

In one aspect of the invention, the change attributes can define the rules by which for example the consumption attributes may be altered dynamically, with the participation of the server computer. For example, the digital content items or digital merchandise compilations may be enabled to be used as collateral in an Internet enabled social game, where the gaming rules associated with the social game (enabled by a third party computer system for example) may result in a defined data communication being sent to the server computer of the present invention, triggered by a game event associated with the social game, and this data communication may result in an automated change to the attributes associated with the digital content items or digital merchandise compilations.

The computer network implemented system, in a further aspect, establishes a log of actions of the user or group of users relative to the digital merchandise compilations, which is dynamically updated based on such actions to establish a unique history for the digital merchandise compilation based on such actions, and such history defines or adds to the unique characteristics of the digital merchandise compilations.

The action logs may be exposed to administrative users to provide insight and telemetry related to the digital media objects, users and their actions within the computer system. These insights may prompt specific feedback or actions on behalf of the administrative users in order to optimize the computer platform to achieve certain business objectives including the number of active users on the computer platform (reach) frequency of use of the computer platform (engagement) and revenue generated by the computer platform.

In a further aspect of the invention, the computer system may also enable the definition, and association with the digital merchandise compilations of one or more “super-attributes” or “change attributes”, or criteria that enable the alteration of the consumption attributes, by selected users (for example administrative users) or based on specific actions (such as use of the digital merchandise compilations in one or more games associate with the computer system, with specific game outcomes). Examples of possible super-attributes include age of the digital merchandise compilation, number of trades or games involving the digital merchandise compilation, or level of scarcity or relative scarcity of the digital merchandise compilation (based on one or more associated attributes, including for example the number of users in the computer system that possess digital merchandise compilations with the same attributes or similar attributes, possibly as compared to the number of users in the system that possible digital merchandise compilations with different attributes). The super-attributes may be understood as attributes associated by the computer system with the digital merchandise compilations that are impacted by one or more other attributes defined or tracked by the computer system. The super-attributes may also be understood as selected attributes that the system permits to be modified based on controlled circumstances.

It should be understood that the various attributes associated with the digital merchandise compilation, or changes to these attributes, authorized through the computer system of the invention, in one aspect of the invention, may impact the contents or functionality of the digital merchandise compilations, such as points value, cost, appearance, and transferability. The system of the invention may also be linked to third party computer systems, so that the attributes, or changes to the attributes, have an impact in web environments associated with such third party computer systems, for example by enabling rights, privileges and abilities within external computer systems such as subscription based services, virtual worlds or online games.

The present invention also enables new digital content distribution models such as premium content when the content items themselves may be “standard” content items, but two or more digital content items associated with one another, and linked to the computer system of the present invention to associate with the compilation a history of interactions or interest, as tracked by the computer system, creates a perception of value in consumers in the digital media content compilation that exceeds the sum of its parts. Examples are provided below.

It should be understood that “digital merchandise compilations” or “digital media compilations”, as used in this disclosure may refer for example to a single musical file combined with text and graphics defining a composite digital card, as opposed to for example a plurality of associated cards forming a deck. The word “compilation” is used merely to describe a collection of “works” that may comprise any digital content, collected or compiled to form a new work. “Compilation” in this disclosure may also be understood to mean a “collection”.

It should be understood that the application of the consumption attributes (and application of possible change attributes enabling modification in specific conditions of consumption attributes) imbues the digital merchandise compilations, and the digital content items part of digital merchandise compilations, with attributes normally associated with physical articles such as scarcity, tradability, and other similar attributes. The association with these attributes with digital content enables users to form emotional attachments and/or reactions to the digital content object, which generally increases interest in consuming such digital content, which in turn fuels demand for such content and/or increases the price that users are willing to pay for selected content. The system and method enables the creation and management of digital merchandise compilations in a way that enables collector behavior relative to digital merchandise, and provides a basis for collector communities to develop around digital merchandise. Enabling social engagement through virtual collector communities increases the engagement between users and digital merchandise, or associated brands, for example creators of digital content, or entities promoting or distributing digital merchandise.

It should be understood that the Invention provides a unique and innovative computer platform that enables the creation and management of novel and innovative digital media assets, and further enables their collection, trading, and other forms of consumption, that enables users to form bonds or attachments to the digital content, in a way that prior to the invention was only possible in relation to tangible assets. In fact, the present invention leverages the advantages of digital technologies and social networking technologies to enable the development of bonds between users and their content in subtle and innovative ways, and to build community around or in connection with content in innovative ways. Content rights holders (such as artists or labels), or brands (such as companies wishing to leverage the computer platform for example by promoting media assets consumed by users by operation of the platform), by operation of the computer platform of the invention are able to design and implement specific marketing campaigns that direct user consumption in ways that promote their interests including promoting sales or brand engagement. The present invention also, in its implementation, responds to a number of technical challenges and hard to solve user design or social engagement problems, with innovative solutions that are described in this disclosure.

### System Implementation

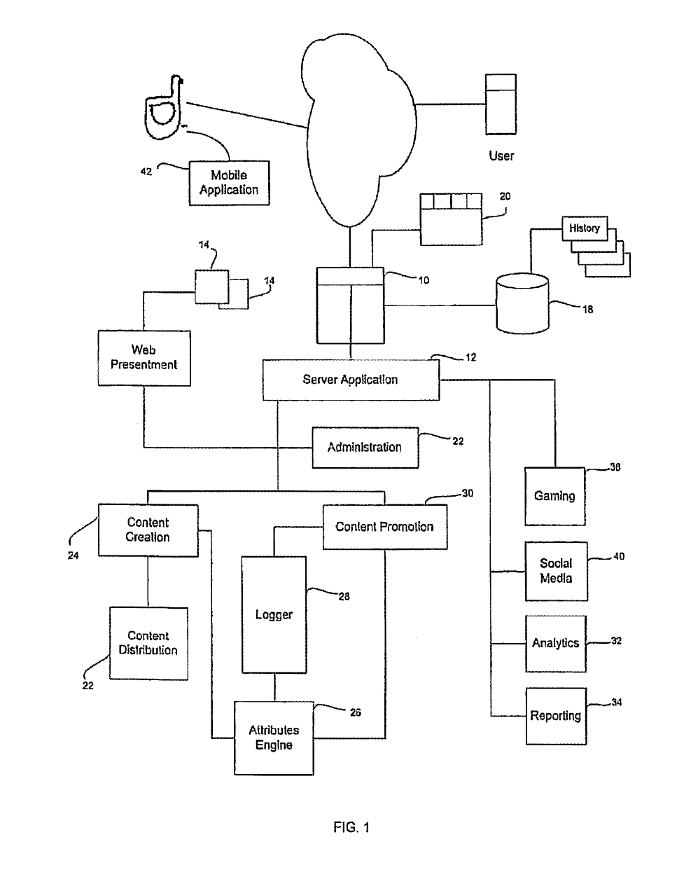

As best shown in FIG. 1, the server computer (10) is associated with a server application (12) that is operable to co-operate with the server computer (10). The server application (12) may be implemented as an application repository. The server application (12) may include a series of utilities that provide computer program instructions to the server computer (10) that enable the computer platform features or functions described in this disclosure. In one particular implementation of the present invention, the server computer (10) may be connected to a network of computers such as the Internet, and the server computer (10) and the server application (12) together provide an Internet platform that provides the computer system or computer platform described in this disclosure.

Various architectures may be used to implement the computer system of the present invention. In one possible implementation, the present invention, the server computer (10) and the server application (12) may be implemented so as to provide the platform features and functions described as a set of web services, which may be provided for example using a SaaS model. In another

As previously stated, the computer system may also include a plurality of network-connected devices. These network-connected devices may connect to the server computer (10) using a client browser implemented to the network-connected device. In addition, the network-connected devices may also implement a client computer program that is configured to interoperate with the server computer (10) and the server application (12). Platform features and functions may be distributed across for example the server application (12) and the client computer program in various possible configurations that a skilled reader will immediately appreciate.

The server application (12) includes or may be linked to a web presentment utility (16) for enabling the creation of web enabled digital content compilations, and also to present a series of Internet pages to enable users to access the platform features and functions described herein.

The server computer (10) may be linked to a database (18) which may include one or more libraries containing digital content items, or collections of digital content items. The database (18) and the administration utility (22) interoperate to ensure that only authorized users have access to associate digital content libraries. For example the administration utility (22) may define for each platform client an area of the computer platform where they are able to access their content and manage projects. This area may be implemented as a content management dashboard and associated utilities of the computer platform and associated content stored to a the relevant client's library defined on the database (18).

In one implementation, a communication utility (20) enables the various digital communications involved in platform operations or communications.

It is important to understand that the server computer (10) and/or other resources linked to, or part of the server computer (10) such as the communication utility (20) may be implemented using one or more server computers, or distributed architectures involving one or more computer, peer-to-peer implementation, cloud based implementations, or any manner of computer architecture.

The server application (12) may include an administration utility (22) for administering hierarchical access to the various resources of the server application (12) based on permissions associated with users or groups of users. The administration utility (22) may for example be operable to define administrative users for customers of the operator of the website (14). Customers may include for example artists or content publishers wishing to leverage the computer platform of the present invention to promote media content, or brand companies or advertisement or marketing organizations representing brand companies, wishing to promote media content enabled by the computer platform of the present invention to promote brands, based on one or more campaigns implemented by operation of the computer platform for the present invention. All of these entities are referred to as “customers” in the present disclosure.

The server application (12) in one implementation includes a content creation utility (24) that enables one or more customer users to upload digital content, for example to the database (18), or establish by operation of the server application (12) dynamic content distribution links. A skilled reader will understand that in one implementation the content creation utility (24) may be implemented as to include features and workflows similar to those using in digital content authoring tools or platforms.

In one implementation, the content creation utility (24) and the web presentment utility (16) may provide a series of functional screens that enable a customer user to assemble digital media content, for example digital merchandise compilations as described. The content creation utility (24) may include one or more dashboards that enable for example a publisher to access various content libraries; import existing content; and/or create new content using one or more tools that are part of the computer system of the present invention or linked to the computer system of the present invention. The content creation utility (24) may also enable an administrative user to select and assemble various attributes with applicable digital content items and digital content compilations. Various menus may be presented to administrative users in order to for example establish the relatedness or associations between digital content items that form part of the same digital content compilations.

The various attributes such as the consumption attributes or change attributes may be implemented using a rules engine or attributes engine (26) that is part of the server application (12) and interoperates with the content creation utility (24). The attributes engine (26) may be invoked in defining the attributed of the digital content compilations for example, and then these are then enforced by operation of the server application (12) because the digital content compilations are configured so that interacting with them requires participation of the server application (12).

Assembly of digital media content by operation of the content creation utility (24) automatically associates the digital media content with one or more consumption attributes by operation of an attributes engine (26), or alternatively using the content creation utility (24) a customer user is permitted to select one or more attributes for enforcement in connection with the resulting digital media content, by operation of the attributes engine (26).

The content creation utility (24) may enable users to manage multiple digital content compilation creation projects; create and access templates for creating digital content compilations and associating with them a set of attributes that may have been used in the past. The content creation utility (24) may include one or more features to modify or tune certain aspects of a digital content compilation, for example existing consumption attributes or change attributes.

In another implementation the computer system includes one or more utilities that enable administrative users to define the relationship of each digital media object in relation to each other to form a collection of media objects. This aspect of the computer system may take the form of a serialized list, a chronological order or an explicit connection between multiple objects in a non-linear form. This aspect may be implemented by enabling the definition of the relationship between certain content objects such that their combination may “unlock” a new content object or affect the properties of the associated objects.

A skilled reader will understand that may different rules may be defined in configuring the computer system of the present invention, and these rules may also define events that are programmed to act as triggers that generate dynamically new rules that determine for example interaction with or based on the digital content compilations.

In one aspect of the digital content compilations, each compilation constitutes a unique collectable or tradable media object. Each digital media object may be associated with a history log (stored to the database (18) for example) which is tracked, updated, and associated with the media objects by the computer system. The history log enables the computer platform of the invention to track user behaviour associated with a particular platform user. Using the history log, the computer platform of the present invention, is operable to establish a novel and innovative digital media asset, namely one that has provenance, in the sense that this term is used in connection with collectible physical assets. In other words, the platform of the present invention is operable to create and link to digital media content, including digital media assets or digital content compilations, a digital provenance. The digital media compilation may be linked with certain rights (such as the right to access or distributed digital content, e.g. whether a song may be transferred, how many times a song may be listed to etc.) or status (for example “super fans” or “super users” may be given different rights, including different content consumption rights). It should be understood that rights and status may be affected by one or more user behaviour parameters that are tracked by operation of the history log.

In one aspect of the invention, the server application (12) may enable the transfer of a digital content item or a digital content compilation from one user to another. The consumption attributes may define a number of aspects of such a transfer, including for example whether an entire digital content compilation must be transferred, or whether one or more digital content items making up a digital content compilation may be transferred without transferring the entire digital content compilation. Various rules related to such transfers may be defined by the server application (12) such as defined user attributes amongst which transfers may be completed. For example only “super users” may be permitted to engage in certain trades, thus providing an incentive for users to increase their engagement with the computer platform. Also, certain credits, badges or incentives may be associated with the computer platform, and transfers may require the redemption of some of these incentives for transfers.

For example, a user may have multiple instances of a specific digital media object and may opt to give one of its duplicates to another user. In this case, the user may be prompted to select a “friend” as defined by a third party application such as FACEBOOK™ or by the computer platform of the present invention. Once the friend is selected, the user may opt to select which instance of the digital media object they wish to gift. This decision may be further informed by the serial number or open date presented on each card as a user may opt to keep an “early edition” in favour of one with a later open date. Once selected and sent, the digital media object is removed from the inventory of the gifter and held in escrow until such time as the recipient logs in at which time the gift is presented to the recipient and it is entered their inventory.

In another example, a user may opt to enter one of their duplicates into a trade with another user. The system will suggest friends who do no have the particular card. Once selected, the computer system may further suggest a card from the friend's inventory that best matches the first user's inventory gaps. The user may then opt to edit or enhance the trade by adding or removing specific cards before submitting the trade. The computer system then notifies the trade recipient of the offer to trade optionally in-game as well as through third party computer platforms such as email platform or social networking environments such as FACEBOOK™. Once a trade recipient logs into the present invention they may be presented with options to accept, reject or edit the proposed trade. Each of these actions will issue an appropriate response to the trade initiator.

The above discussion regarding transfers may also be applicable to trades.

As both gifts and trades serve to retain engagement within the present invention, each successfully completed action may trigger earned credits by operation of the computer system.

A skilled reader will understand that various application of virtual currency are possible in connection with the computer platform of the present invention, and its various features and functions. As mentioned earlier, earned credits may be awarded to users in exchange for performing specific actions predetermined by an administrative user. In one example, a user may be rewarded with earned credits for completing a trade with another user, or for logging into the computer system at a specific time. In another example, a user may opt to watch a specific video advertisement in order to earn credits, or complete a survey that may be created by a customer of the computer platform.

The computer system may also implement a premium credit concept. Premium credits may be purchased using real currency. This may be done for example using a third party billing platform such as Facebook Credits™ or a user's iTunes™ account. A particular digital media object may also be assigned a value in a third party currency system such as Facebook Credits™ directly.

Each digital media object may be assigned a value in earned and/or premium currency. The value of each may be determined by the scarcity assigned to the media object as well as the underlying rights associated with it. In the case where the underlying rights of a particular digital media object are restricted to promotional use and no monetization is permitted by operation of the attributes engine (26), a value may be assigned in earned credits only.

In another scenario, where the underlying rights permit direct monetization, a value in both earned and premium credits may be assigned such that a digital media object may be acquired for a relatively high level of earned credits or a set amount of premium credits. This is intended to provide a reward or incentive to highly active users while encouraging spending from more casual users.

In one implementation, using the administration utility (22), an administrative user may be able to select whether a specific digital media object is promotional or commercial and whether that digital media object is common or scarce.

In one implementation of the invention, the above, results in four tiers of scarcity that define the likelihood of a card appearing in a blind pack as well as the cost of that digital media object in both earned and premium credits.

### Example Tier/Credit Value Chart

| Scarcity Tier | Earned Credits Value | Premium Credits Value |
|---|---|---|
| Promotional common | 25 | N/A |
| Promotional rare | 100 | N/A |
| Commercial common | 250 | $1.29 |
| Commercial Rare | 500 | $4.99 |

In another specific implementation of the present invention, which may be implemented using the attributes engine (26), activities permitted in connection with a particular digital content compilation may be limited using associated rules which may be represented using “Action Slots”. Action Slots may define a set number of gifts or trades that may be engaged in at any given time. In one example, a user may have four Action Slots that can be in used at any given time in connection to a particular digital content compilation. When a user proposes a trade, that pending trade may occupy one of the four action slots. Any completed trade or gift may also cause the Action Slot to “recharge” or become inactive for a set period of time, based on applicable rules. This time may be accelerated by spending credits to buy an “action slot recharge” such that the Action Slot becomes immediately available for use. The application of Action Slots allows the computer system to mitigate potential abuses of the computer system.

It should be understood that the platform may be associated with one or more content distribution engines (25) which may be understood as implementing one or more distributions rights management (DRM) mechanisms for establishing and enforcing digital rights applicable to consumption of digital media assets. It should be understood that the content distribution engine (25) may be, for example, a third party DRM server that may be controlled by a content publisher or content distribution entity that has obtained distribution rights from content owners or publishers. By incorporating a content distribution engine (25) in the computer platform of the present invention, or linking a content distribution engine (25) to the computer platform, the platform is operable to enable consumption attributes in relation to the digital content compilations, or underlying digital content items, such as for example enabling by operation of the consumption attributes transfer of a song by virtue of transfer of a “card” incorporating the song, enabling the play back of video incorporated into a “deck” whether for a limited number of times, or unlimited times, whether using only a registered device or any device. It should be understood that a wide variety of parameters may be defined using the consumption attributes.

In one implementation the attributes engine (26) may be implemented as a computer program utility included in or linked to the server application (12) that enables administrative users of the computer platform to define the various rules that determine the consumption attributes referred to below.

In one aspect of the invention, the server application (12) is operable to establish a novel and innovative computer network implemented user environment as a rules based environment, using known technologies for this purpose, such that associated consumption attributes for a particular digital media object, or digital merchandise compilations, are enforced throughout the various operations that users may wish to engage in for the particular digital merchandise operation. It should be understood that the content creation utility (24) may enable the creation, or the access to, one or more templates defining collections of consumption attributes, as a mechanism to enable customer users to quickly and efficiently create new digital media content, and release or distribute this digital media content, by operation of the computer platform of the invention.

It should be understood that the attributes engine (26) is linked to a logger utility (28) of the server application (12). The logger utility (28) is operable to track each action taken relative to a digital media object linked to the server application (12) or generated using the content creation utility (24). This may be based on the user(s) of the platform who engaged in the action. The logger utility (28) is operable to compile a history log, for example for each digital media object, and store this information to the database (18) and update this log with each action taken relative to the applicable digital media object. The history log may contain information regarding the various owners of a digital media object, associated time information, points accumulated in relation to the digital media object through one or more social games linked to the server application (12), and so on. Further details regarding the history log are provided in the use cases set out below.

The computer network implemented system, in a further aspect, establishes a log of actions of the user or group of users relative to the digital merchandise compilations, which is dynamically updated based on such actions to establish a unique history for the digital merchandise compilation based on such actions, and such history defines or adds to the unique characteristics of the digital merchandise compilations.

The action logs may be exposed to administrative users to provide insight and telemetry related to the digital media objects, users and their actions within the computer system. These insights may prompt specific feedback or actions on behalf of the administrative users in order to optimize the computer platform to achieve certain business objectives including the number of active users on the computer platform (reach) frequency of use of the computer platform (engagement) and revenue generated by the computer platform.

For example digital merchandise compilations such as “decks” as described herein may be released on the basis of editions, where each edition may have certain different attributes as compared to other editions, and each edition may have a finite number of “decks” that include an identifier of the particular edition in question. The computer platform of the present invention enables the monitoring of activities associated with the decks, including for example demand for particular editions of the decks. Based on the information obtained by such monitoring, subsequent attributes associated with subsequent editions may be altered.

It should be understood that the attributes defined using the attributes engine (26) may relate to a number of categories of attributes including for example: credits, decks, cards, modifiers, packs and pack builder rules, scarcity and levels, trades, challenges, gifts, matchmaking, actions, challenges, top cards and wild cards. Further details regarding these attributes and possible impact on user interaction or brand engagement is provided in the use cases below.

A number of other attributes or types of attributes may be devised and implemented to the platform.

In one aspect of the present invention, the attributes engine (26) may be based on a unique form of meta data that enables the definition of a set of properties for a “card” and also a plurality of “cards” to form a “deck”. A “card” and “deck” can only be modified, whether this is by including or removing digital media content items based on the assembly rules that are part of the applicable data structure, yet individual digital media content items, subject to any digital rights management restrictions, may be included within the data structure for example to complete the deck, or add additional permitted features or information to a card.

For example, a “deck” created by operation of the computer platform as a unique digital merchandise compilation may consist of a predetermined number of cards as well as a relative scarcity for each card in relation to the overall deck. For example “scarcity” may be defined by a specific number of instances, or a probability of showing up in a randomly assembled “blind pack” or by price or value of earned or premium credits.

In one particular implementation of the present invention, the attributes engine (26) may implement a series of rules regarding the earning and use of “credits”. For example, in one aspect of the implementation of the present invention, an “earned credit” value may be assigned to each digital media object, which may be calculated in part based on the a level of scarcity associated with the particular digital media object, such that more rare cards are assigned a higher earned credit value. There may also be an earned credit value assigned to all actions of users in connection with the computer system. This may include consuming media, trades, gifts and shares. In this way, the computer system enforces a loyalty loop between users and content where users earn credits by performing specific actions defined by the computer system and can spend those credits for example on digital media objects available through an online store linked to the computer platform. In addition to this, an administrative user may assign a premium price to a particular digital media object, using the attributes engine (26). This premium price may correspond to a virtual currency that may be purchased using real currency, in one implementation of the present invention. It is possible that a digital media object may have a price attribute that is a combination of earned and premium currency. This is also a novel and innovative feature because it allows both promotional and commercial content to be presented within the same transactional environment.

Relationships can also be defined between smaller subsets of cards. In one instance for example, owning three cards may be required to unlock a fourth card. In another example, owning three instances of the same digital media content compilation may improve its overall ranking in relation to challenge activities involved in social games linked to the server application (12).

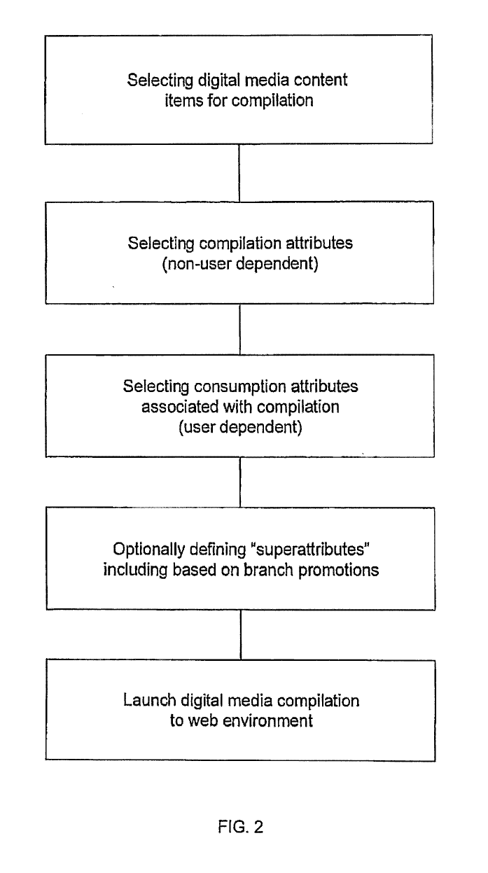

FIG. 2 illustrates one aspect of the method of the present invention, in a representative implementation thereof. In particular, FIG. 2 illustrates the use of the content creation utility (24) to assemble particular digital media compilations, and associated attributes, and also the role of brands that may be associated with the platform to support particular incentives associated with the digital media compilations. The computer platform of the invention, in one aspect thereof, enables the implementation of cross-promotions between content publishers, for example, and brands. In one aspect of the invention, a computer implemented method in accordance with the present invention may include the steps of: a customer user (1) selecting from the customer's digital media library digital media content items for association with one another, (2) selecting one or more associated attributes that define the compilation, including the association of the digital media content items to one another to form the digital media compilation (including for example the number of cards in a deck, sources of content etc., (3) selecting from the computer system one or more attributes that are associated by the computer system with the digital media compilation but that depend on user actions, such as consumption of digital media, trade or transfer of digital media content, TIERS, rules of play in a computer enabled games involving the digital media compilations, and so on (“consumption attributes”), (4) optionally associating super attributes including optionally defining modifying attributes based on one or more promotions involving for example a brand, and defining a code which when provided to the platform by a user enables modification of the attributes associated with the digital media compilation, and (5) initiating the launch of the digital media compilation such that computer platform enforces the one or more consumption attributes regardless of the users or groups of users, or device(s) associated with such user or groups of users, wherein each digital merchandise compilation constitutes a unique media object, where the actions of the users or group of users relative to the media object is defined by the consumption attributes.

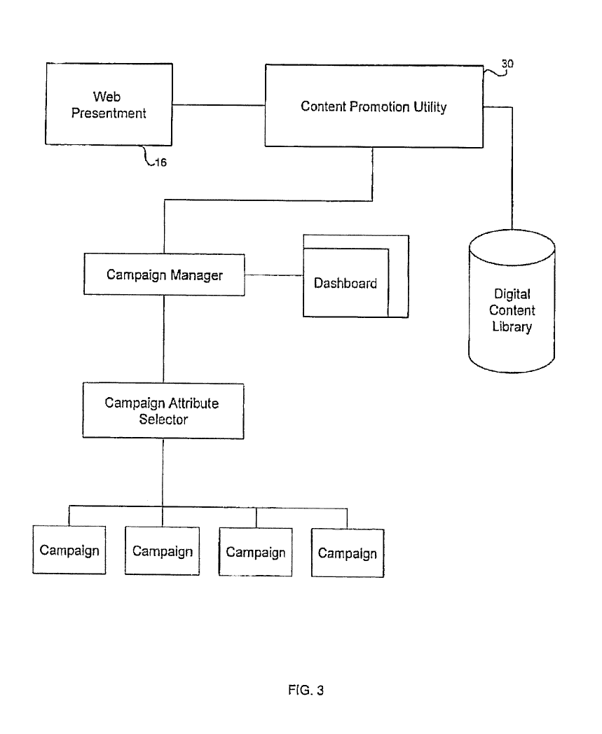

In another aspect of the invention, the server application (12) may include a content promotion utility (30), which is best understood as one or more software utilities that enable customers of the operator of the computer platform to design and launch one or more campaigns that are linked to digital media object created by operation of the present invention. Possible functionality of the content promotion utility (30) is illustrated in FIG. 3. The content promotion utility (30) may be linked to the web presentment utility (16) so as to present to customer users one or more Internet pages for accessing functions of the content promotion utility (30). The content promotion utility (30) may be understood as a campaign manager tool or tools for designing and launching marketing campaigns, including through third party platforms linked to the platform of the present invention, but based on for example digital merchandise collections created by operation of the invention, and also by means of enforcement of a particular set of attributes, based for example in part on campaign objectives of the customer, by operation of the attributes engine (26) as described. Specific examples of use of the content promotion utility (30) are provided below in the use cases.

For example, the content promotion utility (30) may present a campaign manager that includes a campaign attribute selector. The content promotion utility (30) may be linked to a digital content library that includes for example promotional digital media objects used by the customer. Whether based on past campaigns or based on new campaigns a customer user may structure and launch a campaign that includes multiple attributes, including attributes discussed in this disclosure. A dashboard may be provided and linked to the campaign manager so as to enable the customer user to monitor the performance of campaigns relative to established parameters. The dashboard may use data from the analytics engine (32) (referred to below).

Optionally, the computer platform of the present invention can include or be linked to an analytics engine (32) that may be linked to the logger utility (28), and based on one or more analytical processes or tools (including access to third party analytic functionality by integrating third party technology into the analytics engine (32) of the present computer platform, or linking the analytics engine (32) to third party analytics functionality available as a web service), the analytics engine (32) is operable to enable the analysis of metrics based on user actions relative to digital media objects created and tracked by operation of the present invention, and associated promotions, for example those enabled by operation of the content promotion utility (30).

The resulting analysis data may assist for example a customer user in configuring promotions or marketing campaigns by operation of the content promotion utility (30), and also may yield useful insight into specific digital merchandise compilations or associated attributes that may resonate with users that fall for example into particular groups based on demographics or interest. The analytics engine (32) may also provide insight into user groups based on behaviour within the present invention. In one example, users may be classified into categories based on behavioural profiles such as super connectors (users who drive reach and engagement by interacting with other users,) collectors (users who actively acquire content objects quickly or with particular attention to the providence of a card,) lapsed users (who exhibit a reduction in activity level.). The analytics engine (32) combined with the promotion utility may be combined to target specific promotions to specific behavioural profiles.

The analytics engine (32) may also be linked to a reporting utility (34) that is operable to generate, based on output from the analytics engine (32) a variety of reports or feeds relating for example to recipient metrics such as statistics for example for the number of specific actions for particular digital merchandise compilation, or particular types of digital merchandise compilations to define activity level reports, and so on. The feeds may be used for example automatically in connection with the operation of an ad server in regards to placement of ads in the various web pages that may be associated with the system of the Invention.

For example, the analytics engine (32) may enable the generation of analytics data providing the number and relative percentage of users who exhibit specific desired behaviour or the absence of this behaviour. In one scenario, the analytics engine (32) may initiate an alert to the customer user when a certain percentage of users is underperforming in number of trades issued or number of log ins per day. In another instance, the customer user may wish to identify all “heavy users” who generate the most activity in the system. The customer user will then be able to use the content promotion utility (30) to provide specific missions and rewards targeted to these specific users. It should be understood that the analytics engine (32) may also generate analytics data which may act as triggers for other functions based on predetermined parameters. For example specific user behaviour identified by operation of the analytics engine (32) may be operable to initiate automated functions of the content promotion utility (30), such as for example automated initiation of promotions based on improvement of user interaction parameters. For example, a specific promotion may include extra points associated with specific activities, and such offering may be provided automatically to users that have demonstrated a decrease in activity levels on the platform.

The reporting utility (34) may feed information to a dashboard presented by the web presentment utility (16) as part of the web pages accessed by customer users through the content promotion utility (30).

For example a content user may define a set of attributes associated with a specific user group such as the types of digital media objects with which to target the user groups based on the measured use of the computer platform for example based on consumption behaviour for the applicable digital media objects. Based on this information, a customer user may select one or more criteria for a promotion directed at the user group, by operation of the content promotion utility (30). For example, a particular customer may want to engage user who were previously heavy users, and are becoming light users.

The communication utility (20) of the present invention may be utilized by a customer user to send an electronic communication to a defined user group to provide a UPC code that is redeemable for example on purchase of a particular good or service through a system that tracks the purchase, and based on the purchase is operable to provide information to the server computer (10), which then initiates the server application (12) to generate and provide to each user fulfilling the conditions of the promotion for example a digital media object created by the operation of the invention, with defined attributes as per operation of the attributes engine (26). For example the game rewards for completing social gaming elements using the digital media object in question may be made part of the associated attributes.

The Internet platform of the present invention is operable to create a novel computer network implemented environment in which digital content compilations may be collected by assembling (whether as a result of gifting, trading and/or online social gaming) “complete” digital content compilations as determined by operation of the associated properties. The properties may be selected or tuned so that certain digital content compilations or “decks” may require increased significant investment of time, “winning” based on associated game mechanics established by the system, and/or applying money consideration (directly or by assigning virtual goods that are bought for money by operation of a transaction utility that is part of the web platform) including buying premium items such as premium packs, or achieving game acceleration based on additional actions.

It should be understood that the server application (12) may include or be linked to a gaming platform (38) that may enable users of the computer platform of the present invention to play one or more web based games or social games that may involve digital media objects associated with the platform of the present invention. For example, a social game enabled by the gaming platform (38) may enable users to use one or more digital media objects as collateral in the game, based on the associated attributes defined by the attributes engine (26).

It should be understood that the gaming platform (38) is operable to embody one or more gaming rules, where a collection of gaming rules define a particular game. A particular game may include a series of game “plays” and associated text, graphical, audio, video or other content that enable one or more single user or multi-user, computer network enabled games. In one aspect of the invention, the gaming platform (38) includes one or more games that as part of the gaming rules include one or more operations involving digital media compilations assembled by operation of the invention. For example a “trade” of digital media compilations may be enabled by one or more social games supported by the gaming platform (38). Or, in another example, one or more digital medial compilations may be used as stakes in a game enabled by the gaming platform (38) such that the “winner” of such game may be the recipient of a transfer of one or more digital media compilations from other players that may have “lost” in the game. This transfer may be initiated by operation of the platform. Points, particulars of “wins” or other results of games may be recorded by operation of the logger utility (28), and may be associated with the history for a particular digital content compilation. The subjective value of the underlying digital media assets or the compilation itself may be increased by virtue of the gaming “wins” associated with that compilation.

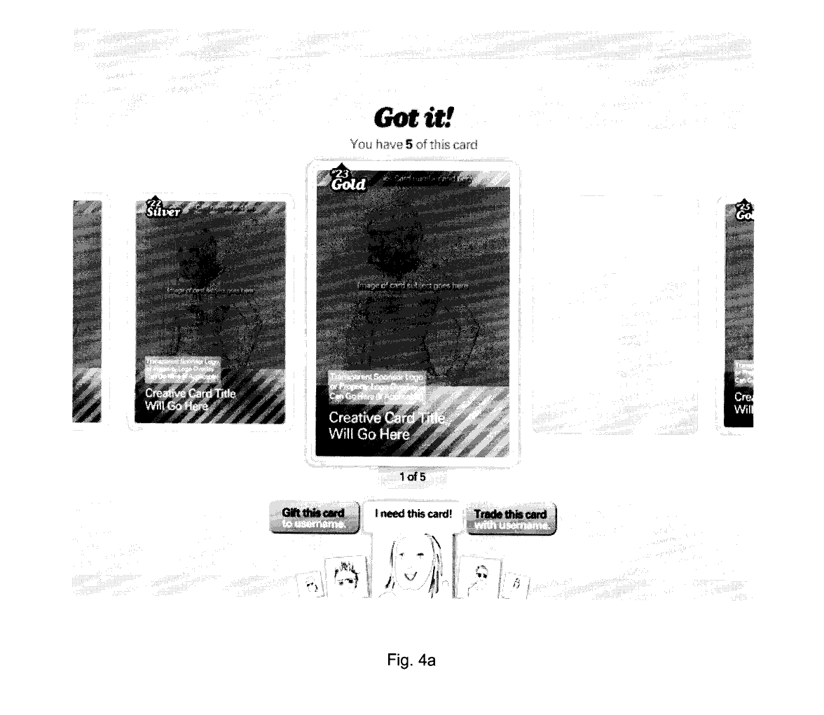

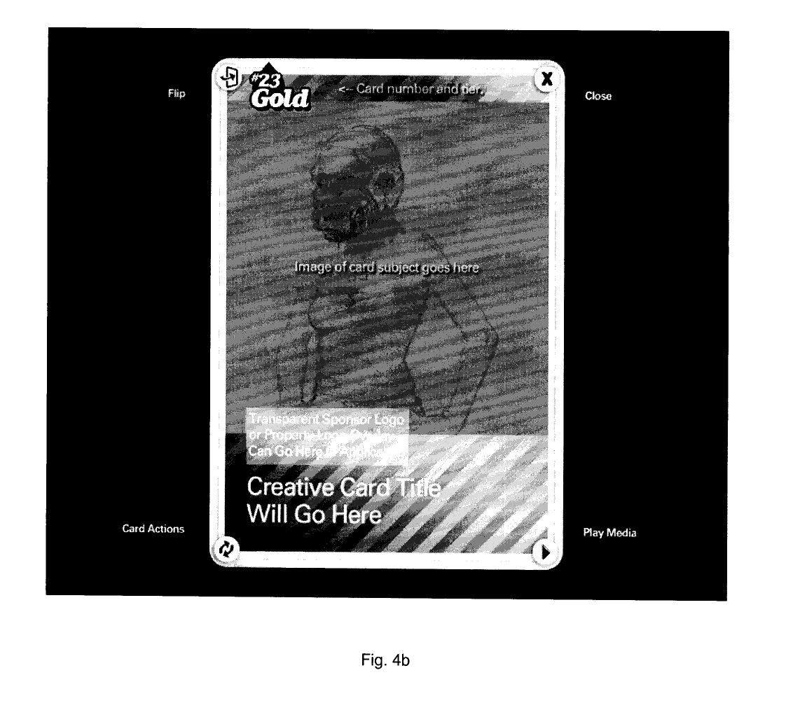

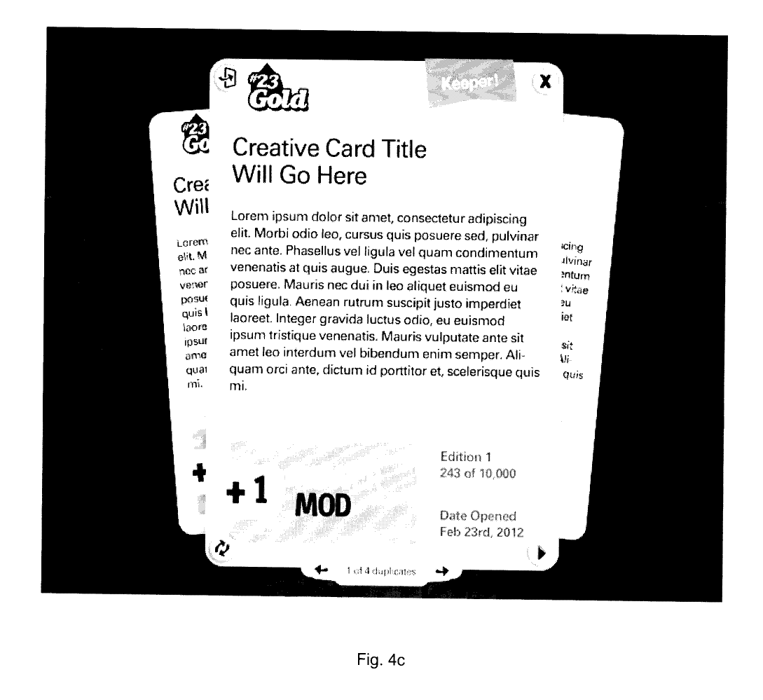

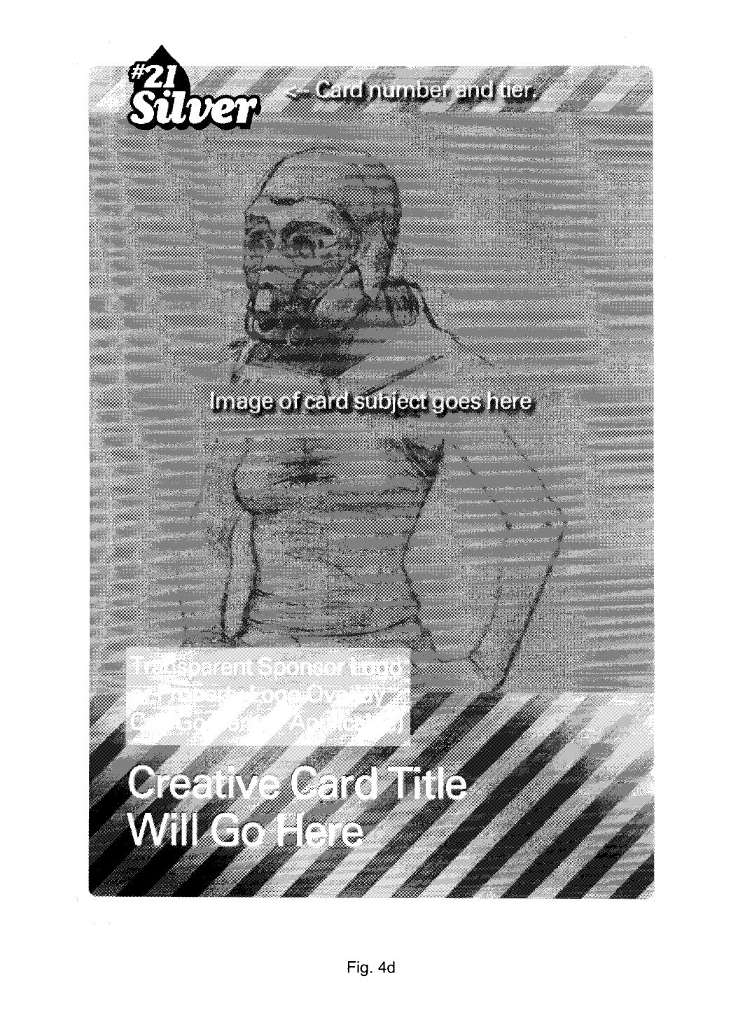

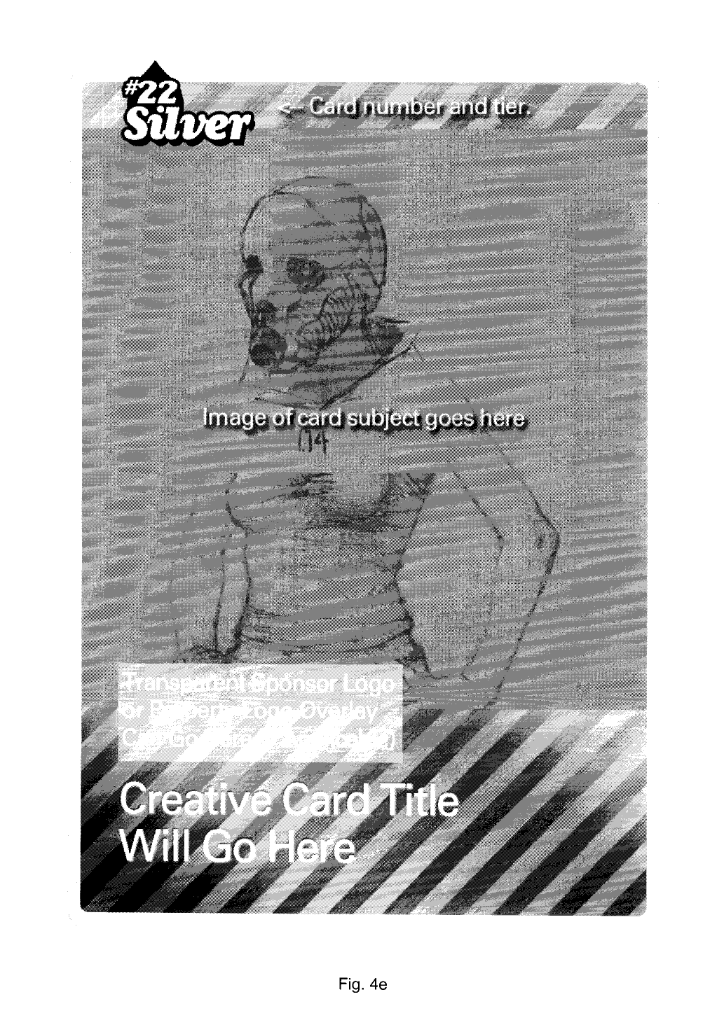

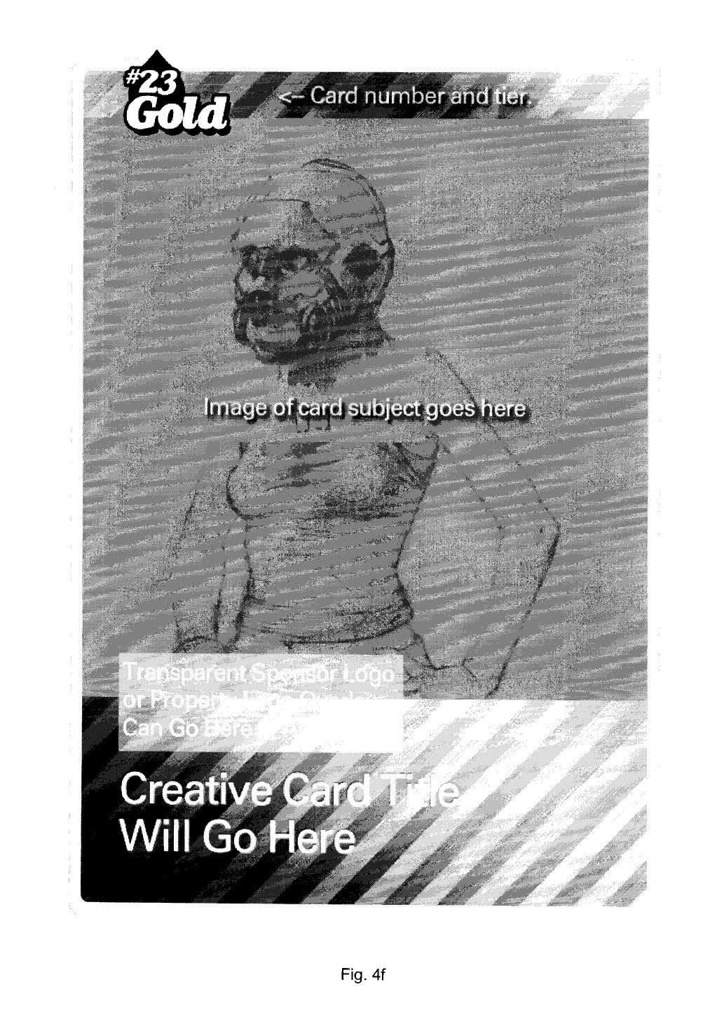

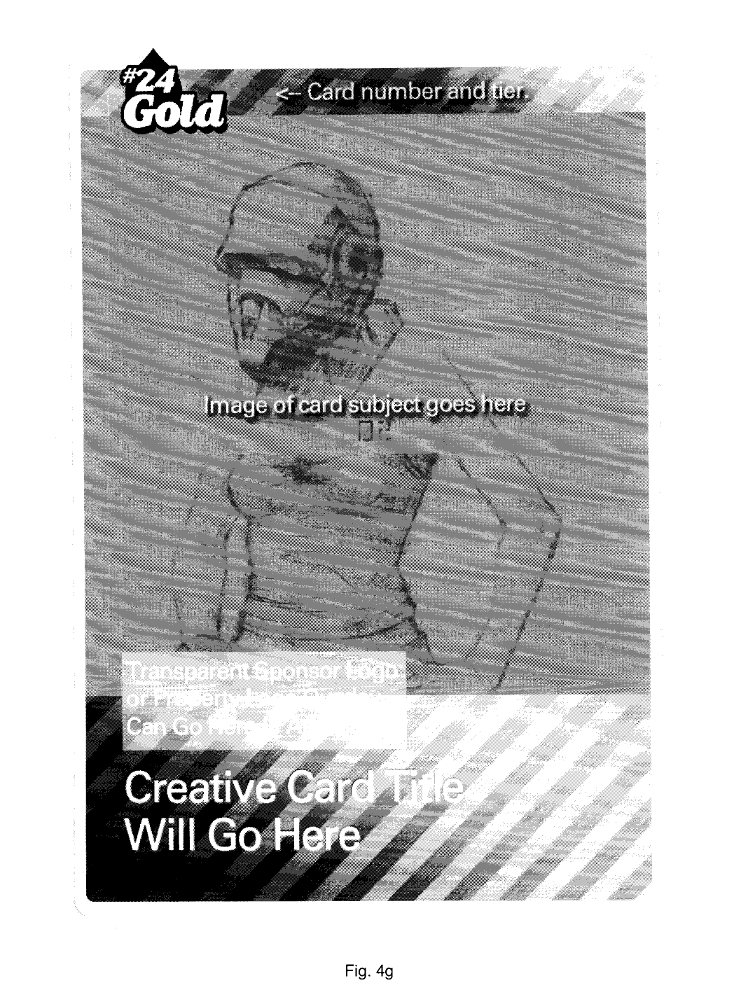

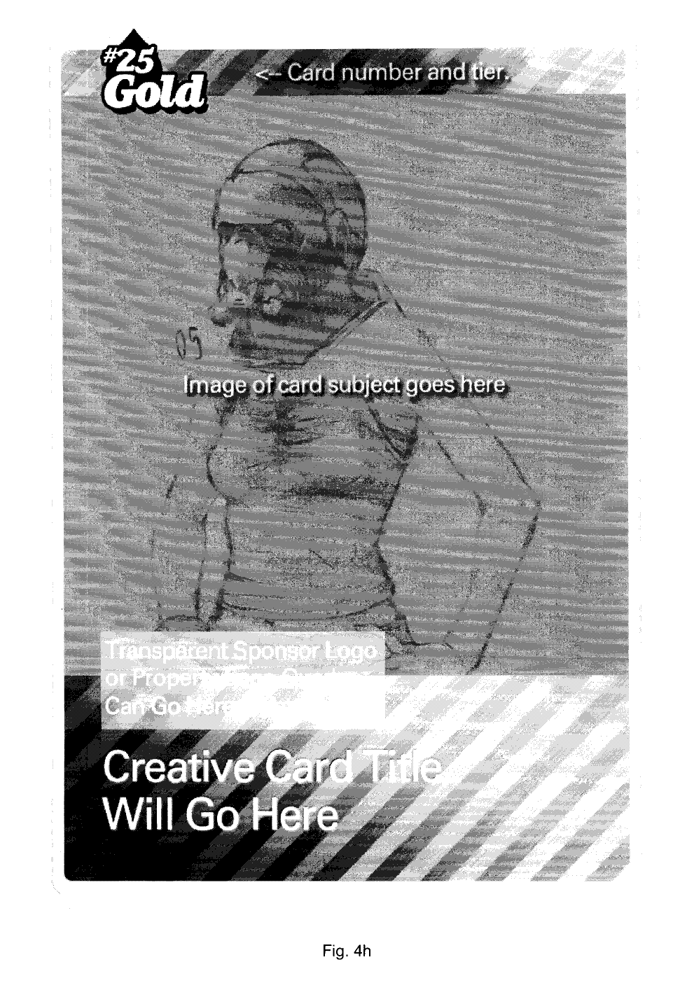

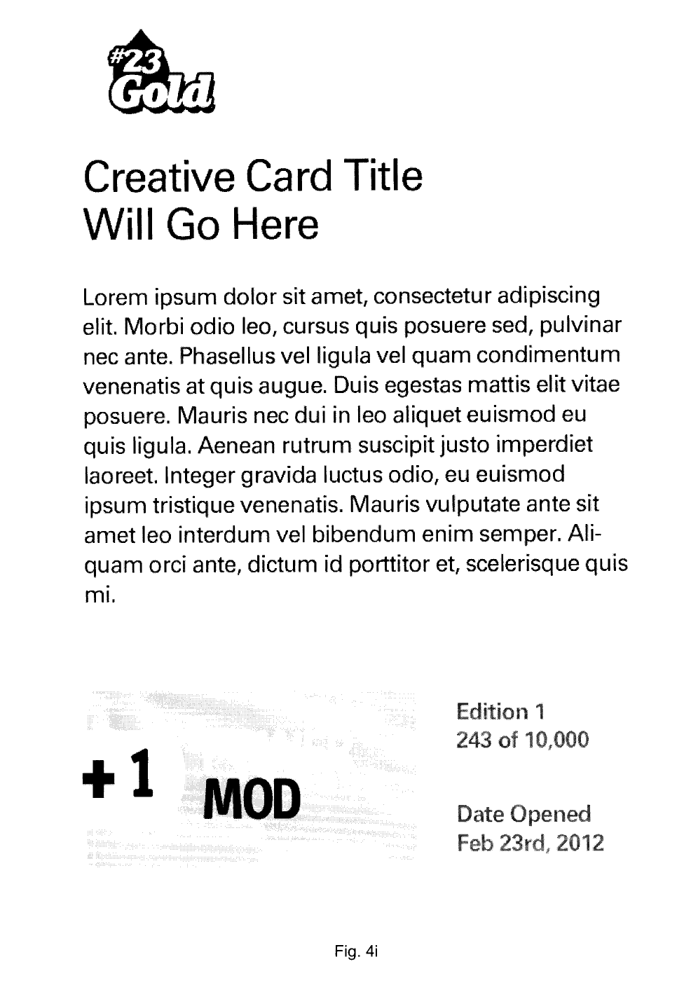

FIGS. 4a, 4b, 4c, 4d, 4e, 4f, 4g, 4h, and 4i illustrate appearance and functions of possible digital merchandise compilations, created by operation of the present invention. More specifically the Figs. Illustrate possible embodiments of decks, including an example of their appearance and possible associated functions.

Various possible implementations or views are possible. In one aspect, the computer system enables different views of digital content compilations, and their digital content items, depending on the context, each context defining associated viewing properties. For example there may be a sharing view that results from a sharing context when the digital media collection for example is displayed in an image sharing site such as PINTEREST™. This context may result in the presentation of a still image and title, along with a ling that allows users to collect/view the media through the computer platform. There may also be an “in game” context that automatically triggers the display of full gaming related functions. Another view may consist of a “single object view” which may be used for sharing rich media on a single page, presented with accreditation to the owner (for example a game user who shared the digital media object), along with a link that allows users to collect the media for example. Anyone viewing this page can view the media according to its associated rules, assigned using the attributes engine (26). A still other view may be an “embedded view”, which may be used for presentation on social networks such as FACEBOOK™, GOOGLE+™ etc. This view may be compressed to show the media only, and end with a link allowing the viewer to collect the media through the computer platform. This view may be used by users to share the content with their friends on different social networking platforms.

### Social Networking Layer

The server computer (10) may include or be linked to the communication utility (20), which may be implemented as one or more communication servers, using known hardware, software, and middle ware, linked to one or more communication networks, for enabling messaging in one or more formats linked with the web. The server application (12) and the communication utility (20) may present a social media engine (40), which may be integrated with the computer platform of the present invention, for example to enable social networking between users of the system of the invention, or groups of users of the system. The social media engine (40) is best understood as a computer program or series of computer programs that provide the means for any manner of electronic communications between users of the system including but not limited to discussion threads, message boards, instant messaging, posts, blogs and so on as well as the definition of relationships between users such as friends or people who have previously completed interactions such as trades. The social media engine (40) may contemplate the use of any existing and any to be deployed form of social media. The social media engine (40) also enables the linking of the computer system of the invention to third party social media utilities such as FACEBOOK™ and others. In this way the social media engine (40) acts as an interface between the computer system and third party computer systems so as to enable the extraction of meta data from the social interactions occurring in relation to the third party computer system to the extent that these are between users of the present computer system, and optionally to the extent that these interactions relate for example to particular digital content, or categories of digital content.

The social media engine (40) may constitute a third party social networking platform such as FACEBOOK™. The server application (12) may enable one or more users to define one or more groups and the computer platform of the present invention may enable a user of the platform for example to engage in social games with the user's network, for example in a web environment associated with third party social networking platform, but in a way that is integrated with the computer platform of the present invention, such that the attributes are enforced, including in connection with the social game as it relates to a digital merchandise compilation for example.

In another aspect of the present invention, various events within the computer platform of the present invention may result in associated events in for example social networking environments that are linked to the computer platform. For example, in connection with FACEBOOK™ this can be accomplished using the Open Graph API of FACEBOOK™. For example, owners of a digital media object, by operation of the computer platform, may “share” or make available for display on a variety of Internet and mobile platforms the media contained within the digital media object. Each share may also be presented with a link enabling the viewer of the share to collect an instance of the digital media object being shared. This link may take the form of a “Collect This” button presented adjacent to the media player displaying the media object.

In one implementation, the original sharer may earn credits for each referral that logs into the applicable digital content compilation through their share. A new user visiting through a share may be granted that media object at zero cost where an existing user entering through the share will be provided with all of paths of acquisition available to them including trading, random trading, purchase, or requesting a gift from a friend.

The user sharing the digital media object may receive attribution for the share, which may be in the form of a “brought to you by” message.

In one aspect of the present invention, a user who owns a specific media object may be allowed to share it by making it available for viewing outside of the present invention and without the requirement of registering. These shares may be presented on popular social networking platforms such as FACEBOOK™, TWITTER™ and PINTEREST™ or may be passed as a link to a media viewer interface of the present invention.

In one implementation, when viewing a share, a user may be shown the digital media object and also one or more elements of the digital media object such as a 30 second clip, or other form of teaser.

Note that users who have not previously engaged in the particular deck or compilation will be rewarded with an instance of the media object where users who have already registered with that specific deck will be prompted to collect that object through a variety of means including a purchase with credits, a trade or a request for gift.

The original sharer receives Earned Credit rewards for each user who collects from their share, in this way providing incentive to drive organic discovery of the particular deck.

### Use Cases and Examples of Specific Attributes

In one example of operation of the present invention, the computer platform of the invention may enable users to collect “cards” and “decks of cards” and also digital “modifier stickers” from associated with bands, movies, TV shows. etc. that are preferred by the particular user. The “modifier stickers” may be a digital object that may be distributed to selected users of the platform, that enables the Integration of for example text and graphical content into one or more particular digital content compilations enabled by the present invention.

As explained earlier, the digital content compilations may be associated with particular functions that enable the user to consume digital content integrated within the digital content compilation, and thereby defining consumption attributes as explained above.

For example a digital content compilation may be associated with the right to “PLAY” associated digital content items such as the ability to listen to and watch audio and video content associated with the digital content compilation. Similarly “cards” incorporated into a “deck” created by operation of the content creation utility (24) may be traded by operation of a one or more associated consumption attributes. For example, the consumption attributes and the gaming platform (38) may define a “CASH CHALLENGE” where one or more platform users participate in a game of war to earn game credits. “GIFT” operations may enable platform users to give “cards” or “decks of cards” to other platform users. The platform may enable the definition of “SCRAMBLES” involving a group of platform users that randomly swap “cards” and receive credits. The computer platform may also define one or more campaigns for generating “WINS” that may involve earning real world prizes (made available for example from a brand engaging in a promotion through a platform) by completing “decks” and other missions within the web environment enabled by the platform. It should be understood that many different consumption parameters, games, and campaigns may be defined.

The section below serves to illustrate one or two scenarios showing the scope of user activities, behaviour, and engagement that may be enabled by operation of the present invention.

A fan may be viewing his/her favourite TV show's website looking for photo galleries from the latest episode, and is presented a web object that may refer for example to a “deck” available through the website, for example by operation of an embedded application included in the website and linked to the computer platform of the invention.

For example, the website may present to the fan in question a free starter “pack” (comprising randomly selection of media objects or “cards” and that this random selection may be further informed by certain scarcity properties defined for each card such that some cards are more likely to appear in a pack than others) upon signing into a game presented by the website, using for example the fan's FACEBOOK™ login.

While viewing his pack, the fan is prompted that he has completed the “deck” at only a 30% level, and that he should trade duplicates with his friends to complete the deck. By selecting a card that the user “needs” or is not in possession of, the computer system may present certain “friends” as defined by the social media engine (40) that are in possession of the specified card. Selecting one friend will trigger the computer system to suggest a trade, or a selection of cards from each user based on cards in each other's possession that may assist in the completion of the particular deck. In another scenario, the user may select a “random trade” that would prompt the computer system to match the user with another user of the computer platform that would create the most compelling or high value trade. In either scenario, the recipient of the trade suggestion would have the ability to edit the digital media objects proposed in the trade and resubmit to the originating user, or reject the trade, or accept the trade as originally proposed.

Once a trade is accepted, the computer system would then transfer ownership rights of each media object or “card” to the new owner.

In defining digital content compilations and associated attributes, the content creation utility (24) in co-operation with the attributes engine (26) may define “tiers” with selected digital content compilations, and associated tier completion rules as defined herein. For example, trading or other actions may trigger changes in “tier” status for the fan's digital content compilation (e.g. BRONZE, to SILVER, to GOLD). The tiers may be used to provide incentives to increase activity levels and associating engagement with the platform. For example, a graduation to a tier may unlock new game play mechanics in such as cash challenges, missions, etc. A skilled reader will also understand that graduation to tier levels may result in a particular digital content compilation becoming more “rare”. It should be understood that a particular deck, by operation of the invention, may be operable to display information regarding the statistics for the deck such as the number of decks with similar attributes.

Consistent encouragement from game mechanics implemented to computer platform, by operation of the gaming platform (38), may trigger for example communications to the fan on how to gather more relevant cards, complete levels, provides updates on milestones accomplished, and incentives to encourage continued engagement such as a FREE CARD. Games may be associated with credits, which the fan may accumulate, and that results in the logger utility (28) updating the fan's profile on the database (18).

The fan may decide to enter into a CASH CHALLENGE enabled by the computer platform of the invention. For example, through a particular CASH CHALLENGE, enabled by the gaming platform (38), a number of rules/operations may be enabled. For example, the fan may opt to challenge any players in an eligible tier. For example a BRONZE challenge may take place with all BRONZE keepers in the deck. A SILVER challenge for example may include all holders of decks in the BRONZE and SILVER tiers. The value of a CASH CHALLENGE may be determined for example by the odds, based on the value of each deck and its chance of winning. Players can choose to try a higher risk challenge to advance faster through the game, but with less chance of winning.

The value of a deck may be assigned by adding up the numeric value of all of a player's KEEPER cards, thus a stronger deck will have a higher number. Modifiers may be linked to KEEPER cards that may determine the outcome. These modifiers may be randomly assigned for example and based on luck the fan may have been assigned for example in a deck, two cards with strong modifiers enabling the fan to win certain challenges and thereby collecting credits from the “bank” associated with the computer platform.

Once a challenge is completed, a modifier may be released (and therefore cease to apply, perhaps until it is “recharged” through selected activities associated with the computer platform.

The fan may also participate in a SCRAMBLE. The fan may select a deck, or selected cards in a deck to submit for participation in a SCRAMBLE. The fan may select one or more other players from an “eligible scramble player list”. For example, Player 2 may have entered 4 cards and Player 3 may have has entered 2, and Player 4 may have entered 2 cars. Once all agree to the SCRAMBLE, the server application (12) shuffles the cards between the group to initiate the sample on a random basis. It is possible of course that one or more of the players will receive back the same cards that they submitted. But likely one or more of the players will receive a different card based on the SCRAMBLE. The SCRAMBLE may result in a new deck, and associated with this new deck may be differentiated set of rights or attributes.

For example, the fan may have logged into the computer platform seven days in a row, which may result in the automatic communication of a new card to the fan. The computer system may also issue to one or more WILD CARDS. The WILD CARDS will be added to the fan's deck or card inventory, A website presented to the fan when he logs into the computer platform, by operation of the web presentment utility (16) may display up to date information regarding WILD CARDS such as information explaining associated campaigns or missions. For example, a web object entitled “WILD CARD INVENTORY” may explain that if the fan collects three of a specific card, the system may assign a specific number of redeemable credits. The notice from the computer platform may also include the fact that the fan already has two of the three relevant cards. The fan may be assigned from time to time a certain number of action “slots” enabling for example a trade. The fan may use such a “slot” and trade for the missing card in order to fulfill the requirements.

The invention also contemplates for example BONUS WILD CARDS, which may provide extra benefits such as credits if the fan engages in some related activity, which for example, may consist watching an advertisement from a promoter such as a brand. The fan does this and collects the extra credits.

It should be understood that various incentives may be associated with the computer platform, such as the extra credits associated with BONUS WILD CARDS may be sponsored for example by a brand.

The present invention also contemplates the association of additional incentives linked to media outside of the computer platform of the invention. For example another BONUS WILD CARD may provide that if the fan tunes into a particular show and obtains a code, and this code is provided to the computer platform of the Invention, then a specific amount of extra credits may be collected.

It should be understood that the logging utility (28) is logging the associated operations, and the logged history is being analyzed by the analytics engine (32). Based on the results, the computer platform may automatically for example issue new WILD CARDS to selected players so as to encourage certain activities.

### Story-Verse Platform

In another example of the operation of the present invention, the computer system may implement a story-verse platform (which may be implemented as part of the server application (12)) that enables users to construct “story combinations” as further explained below. This aspect of the computer platform may also be understood as a “digital narrative application” or “DNA” or creating digital narratives, as described, in a way that is very engaging for users and provides new opportunities for leveraging existing content, regardless of the medium or source.

As previously explained, the present invention enables the formation of sets of digital merchandise compilations that have a defined relationship with one another. For example, in one implementation, the attributes engine (26) may include one or more attributes that define the relationship between different digital media objects. For example, the computer system may be used to define different “types” of digital media objects, and the rules for building for example a “story” using different media objects, including different “types” of digital media objects that constitute different “building blocks” for a story.

In one particular implementation of the present invention, the computer system of the present invention may be used as an Internet platform that enables the formation of digital media objects, which are linked to the server application (12) of the present invention, in order to enable one or more users to acquire defined digital media objects that may be constructed by users to form “storied” based on a collection of digital media objects, based on parameters set using the attributes engine (26).

In one implementation, the computer system of the present invention provides a “DNA story-verse platform” that engages users by enabling them to collect content digital media objects that are interrelated through the server application (12) so as to be connected to a set of story options. Users construct a story by collecting defined digital media object and engaging in activities in relation to digital media objects (such as actions as required in connection with a particular campaign). This enables users to be play a role in defining the story, thereby creating new and innovative content that is engaging. Of particular interest is the fact that digital media objects can be derived by existing content to build new content that is engaging, possibly through different media.

For example, content can be taken from a cartoon show episode (“content segment”), produced for television, and separated into digital media objects containing particular portions of the cartoon show, which may be defined by a particular “story line” within the cartoon. New content could be created to enrich the “story line” choices that may be made by users for example, thereby creating an enhanced set of digital media objects related to the content segment. The attributes engine (26) defines the rules for users collecting the relevant digital media objects, and what is required and what is possible in terms of collecting digital media objects—and linking digital media objects to one another to construct a derivative of the content segment that may embody “story line” choices of the user for example. These user defined collections of digital media objects will, based on the attributes engine (26), consistent with one of the combinations permitted by the administrator, however, this implementation of the computer system involves the user as a co-creator, and through this role creates a connection between the user and the content that is not possible using prior art platforms and content. Users may access information regarding other available and related digital media objects, such as digital media objects that relate to a particular “story line” that a user wants to add to their desired story arc. The user may try to acquire these digital media objects, for example by purchasing the desired content, redeeming points for the content, or trading with another user. A person skilled in the art will understand the novel and innovative engagement opportunities that the computer system creates through these interactions.

It should also be understood, that in certain implementations it may be possible to enable users to add their own signature or content to a story combination (such as a voice recording that a user may add to the end of the story combination or a digital drawing created by them, or assembled using for example one or more content creation tools linked to the system or to the content provider). This further enables the user to make the content “their own” or associate their fingerprint with the content.

It should be understood that the user collects and combines digital media objects into a user directed story combination of these digital media objects, and this story combination itself is linked to the server application (12), such that it is unique and associated with consumption attributes. The user in effect “owns” their story combination. Story combinations are compiled using defined content, and based on attributes that constitute a set of possible combinations of digital media objects based on permitted “story tine” permutations. Nonetheless the user makes the story combination “their own”, and they know that in effect the story combination, through the system, is unique or scarce. This provides new and innovative opportunities for engagement of users using content.

What follows is further explanation of certain aspects of a story-verse platform using digital media objects that are building blocks that may be collected and arranged

Stories, regardless of form, are generally made up of the following building blocks consisting of: (i) characters, (ii) locations, (iii) props, (iv) events, and (v) scenes.

Carefully threaded together, these elements combine to create powerful story forms defined by the technology and business models that enable them.

Books, Comics, Movies, and Shows are linear forms that encourage the viewer to imagine a universe beyond the narrative. This can spawn franchises including sequels, spin-offs, novelizations and more.

Digital platforms provide an opportunity to recast these story-verses in new forms and present new business and content monetization opportunities. However, the current state of the art is at relatively early stages of defining these new forms, however, it is likely that these new forms will reflect certain key properties that are defined by available digital technologies.

The story-verse platform provided by the present invention is an ever-expanding platform that turns story building blocks (referred to as “Cells” in the present disclosure) into digital collectable merchandise and enables a new form of narrative expression.

Cells may contain video and pictures that represent characters, locations, props, events and scenes, for example. Users or Players collect and combine Cells to unlock new pieces of the story-verse. These narrative chains may be referred to as “Threads”. Threads tell Players what Cells they need to collect in order to unlock a new Cell. Unlocked Cells then reveal a new part of the Thread and a new set of Cells that must be collected.

Players can also freeform interact with Cells to see which ones connect and what new Cells they may unlock as a result.

For example, a thread may require three main characters and a location to unlock a scene involving all four of these elements. Once unlocked, the Player may notice a bystander in the scene that they have in their collection. If the Player combines that scene with the bystander, a new Cell is unlocked containing a view of that event from the character's perspective. This may create an entirely new thread based on that character.

Besides narrative threads described above, a Player's collection can be organized in multiple threads including time, character and location. Players can also define their own threads eventually.

Each Cell is a unique object. Each has a serial number, edition, open date and history, by operation of server application (12). In one particular implementation, once a new Cell is opened, it cannot be traded, sold or given away unless the Player has a duplicate, or pays to clone that Cell. When she does her identity becomes part of the history of that new Cell.

Cells can be bought from the story-verse platform, for example through an on-line store that is part of the platform or linked to the platform, for example in “blind packs” and individually on a limited release basis. Blocks that are needed to complete a thread can be bought in-context as well.

Players spend credits earned through game play, engaging with a sponsor advertisement or by cash purchase for example. On a subscription basis, Cells on the main thread can be unlocked for the player in a set release schedule, while still allowing for freeform discovery elements to remain.

As explained before, the computer system of the present invention may incorporate or link to a social media engine (40). Making story-verse interactions social is one aspect of collectability of story combinations based on the present invention. Players can “share” or display their Cells through various social channels and friends can also browse each other's collections. Through these windows and through prompts on missing Cells Players can buy, gift and trade with each other. Players can pay to clone a Cell they have to complete an attractive trade or to give it to a friend in need.

It should be understood that the story-verse platform of the present invention may be implemented as a multi-platform accessible through iOS, Android, Xbox and connected TVs as well as through a standard browser.

One advantage of this aspect of the invention is that story tellers are no longer restricted to a specific length or narrative path. Some stories may be an hour long once completed. Others may be stand-alone shorts. Cells also give storytellers the ability to fill in details on a character, location or prop that may not have specific narrative value but may help add depth to the story-verse, or have a special meaning for the Player.

In one implementation, using a hierarchical editorial structure similar to that used at Marvel, individual story lines can be pursued by a writing team while retaining the integrity of the over-arching story-verse. A master view of all Cells and their connections may be used as a management tool for creators, and may be implemented using the content creation utility (24) that enables the management of media and definition of rules for defining particular story combinations. The content creation utility (24) allows the writing team to explore user engagement scenarios, create derivative rule sets, and access analytics in defining derivative rule sets.

Real time data on trending characters and storylines may be generated by analytics engine (32) and can inform where the production focuses its energies, constantly refining and directing where resources are spent to optimize Player engagement.

With an average clip length of 1 minute, a story-verse defined using the computer system can contain over 400 scenes and hundreds of character, location and prop cards for the production cost of a single season of television.

It should be understood that the creation, distribution, sharing and so on of story combinations may be associated with various mechanisms for monetizing virtual goods including for example exampled subscription, micro transactions, advertising and so on.

### Further Details of Possible Implementation

In one aspect, the present invention may be implemented as a computer program. Server application software and databases may execute on both centralized computers and distributed, decentralized systems. The Internet or any other private or public network (for example a company's intranet) may be used as the network to communicate between the centralized servers and the various computing devices and distributed systems that interact with it.

In one aspect of the computer program, the user interface may be provided to a user via a web server that is operable to deliver web pages. In particular the computer program includes a web presentment utility that is operable to generate a series of web pages that incorporate content generated by operation of the present invention.

The present invention may also be operable over a wireless infrastructure. Present wireless devices are often provided with web browsing capabilities, whether through WAP or traditional means. The user interface of the present invention may be provided to the wireless devices, with processing occurring on the server side of the communication channel or any server associated with such a network. Furthermore, the present invention may include a mobile application (42) as referenced below.

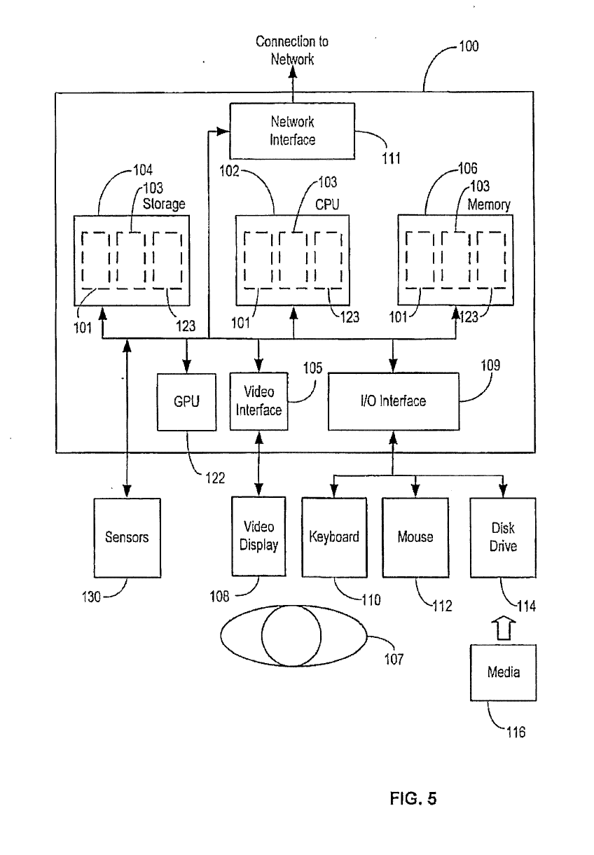

The present system and method may be practiced in various embodiments. A suitably configured computer device, and associated communications networks, devices, software and firmware may provide a platform for enabling one or more embodiments as described above. By way of example, FIG. 5 shows a generic computer device (100) that may include a central processing unit (“CPU”) (102) connected to a storage unit (104) and to a random access memory (106). The CPU (102) may process an operating system (101), application program (103), and data (123). The operating system (101), application program (103), and data (123) may be stored in storage unit (104) and loaded into memory (106), as may be required. Computer device (100) may further include a graphics processing unit (GPU) (122) which is operatively connected to CPU (102) and to memory (106) to offload intensive image processing calculations from CPU (102) and run these calculations in parallel with CPU (102). An operator (107) may interact with the computer device (100) using a video display (108) connected by a video interface (105), and various input/output devices such as a keyboard (110), mouse (112), and disk drive or solid state drive (114) connected by an I/O interface (109). In known manner, the mouse (112) may be configured to control movement of a cursor in the video display (108), and to operate various graphical user interface (GUI) controls appearing in the video display (108) with a mouse button. The disk drive or solid state drive (114) may be configured to accept computer readable media (116). The computer device (100) may form part of a network via a network interface (111), allowing the computer device (100) to communicate with other suitably configured data processing systems (not shown). One or more different types of sensors (130) may be used to receive input from various sources.

The present system and method may be practiced on virtually any manner of computer device including a desktop computer, laptop computer, tablet computer or wireless handheld, game console or connected TV or other network connected entertainment devices.

It should also be understood that the server application (12) may be configured to communicate with one or more wireless devices, enabling location based communications to recipients, where communications are optimized by operation of the server application (12) or a resource linked to the server application (12) for particular wireless devices. As shown in FIG. 1, the server (10) may be linked to a wireless gateway for enabling wireless communications between the server (10) and multiple recipients registered to the system. In addition, the computer program of the present invention may include one or more software components that provide a mobile application (42) (which may be implemented for example as an iPhone™, Android™, BlackBerry™ application, or mobile application leveraging another mobile platform, to enable the functions or operations to be described using a mobile device. The mobile application (42) may be installed on a mobile device, enabling a sender to use the mobile application (42) to manage communications sent based on location by operation of the present invention. The mobile application (42) may also enable a user of the mobile device to access one or more resources of the server application (12) from a mobile device. For example, a user of the platform of the present invention may be notified when another user of the present invention is within a geographical proximity. Interactions performed in person may then have a different outcome, reward or impact on the particular digital content compilation based on that proximity. Some actions or properties of the digital content compilation may only be activated by physical proximity. For example, players may be able to engage in a “Bump” that exchanges random cards between players based on proximity.

The present system and method may also be implemented as a computer-readable/useable medium that includes computer program code to enable one or more computer devices to implement each of the various process steps in a method in accordance with the present invention. In case of more than one computer devices performing the entire operation, the computer devices are networked to distribute the various steps of the operation. It is understood that the terms computer-readable medium or computer useable medium comprises one or more of any type of physical embodiment of the program code. In particular, the computer-readable/useable medium can comprise program code embodied on one or more portable storage articles of manufacture (e.g. an optical disc, a magnetic disk, a tape, etc.), on one or more data storage portioned of a computing device, such as memory associated with a computer and/or a storage system.

1. A computer network implemented system for creating and disseminating unique digital media content compilations, characterized in that the computer system comprises:
at least one computer network connected computer server linked to a database, and a server application linked to the computer server, wherein the server application and the computer server implement one or more computer utilities that:
(a) enable one or more administrative users to select digital media content items from one or more content libraries stored to the database and form therefrom digital media content compilations, and
(b) enable the administrative users to select one or more rules related to the consumption of the digital media content compilations, including the rights of users or groups of users to access/retrieve and share, trade and/or transfer or otherwise use the digital merchandise compilations, or components thereof (“consumption attributes”);
wherein the computer server is configured to connect to one or more network connected devices to enable users to interact with or otherwise consume the digital media content compilations, in a way that enforces the one or more consumption attributes regardless of the users or groups of users, or network connected device{s) associated with such user or groups of users;
wherein each digital merchandise compilation constitutes a unique digital media object, where the actions of the users or group of users relative to the unique digital media object is defined by the consumption attributes.

2. The computer system of claim 1, characterized in that the one or more computer utilities provide a digital content compilation authoring system, wherein the digital content compilation authoring system enables the administrative users to select and apply one or more rules for defining the manner in which the digital media content items relate to one another.

3. The computer system of claim 1, characterized in that the digital media content compilation authoring system permits the administrative users to define one or more scarcity attributes, and associate these scarcity attributes with one or more digital media content compilations.

4. The computer system of claim 1, characterized in that the computer system is configured so that:
(a) users may engage in one or more initial interactions with digital media content compilations, and
(b) after the initial interactions, further interactions require the users to access the server computer using a network-connected device, and the server computer accesses the consumption attributes associated with the digital media content compilation, and determines subsequent interactions using a series of client/server interactions with the server application that are determined by the consumption attributes.

5. The computer system of claim 4, characterized in that the consumption attributes include one or more attributes associated with a digital media content compilation that are impacted by one or more other attributes defined by or tracked by the computer system (“super-attributes”).

6. The computer system of claim 5, characterized in that the super-attributes include one or more of:
(a) the number of trades or games authorized for the digital media content compilation;
(b) the transferability of the digital media content compilation and associated rules;
(c) scarcity rules for the digital media content compilation; and
(d) use of the digital media content compilation in connection with one or more network-connected games

7. The computer system of claim 4, characterized in that the consumption attributes are based on one or more interactions between a user and a third party computer system and/or or one or more third party computer system interactions involving a particular digital media content compilation, and a network-connected device is configured to collect information regarding said interactions and transfer this information to the server computer, and the server application defines one or more attributes that are linked to the interactions and triggers one or more super-attributes that define one or more changes to the consumption attributes for the digital media content compilation, thereby enabling the digital media content compilation to interact with the third party computer system interactions.

8. The computer system of claim 1, characterized in that the server application establishes a log of actions of the user or group of users relative to each digital media content compilation, which is dynamically updated based on such actions to establish a unique history for the digital media content compilation based on such actions, and such history defines or adds to the unique characteristics of the digital media content compilation.

9. The computer system of claim 1, characterized in that the computer system is configured to assign digital provenance with the digital media content compilation.

10. A computer implemented method for creating and disseminating unique digital media content compilations, characterized in that the method comprises:
(a) one or more rights holders providing one or more digital media content items to a database linked to at least one server computer connected to the Internet;
(b) one or more administrative users selecting a plurality of the digital media content items from which to initiate the server computer to create a digital media content compilation;
(c) the administrative users selecting one or more rules related to the consumption of the digital media content compilation, including the rights of users or groups of users to access/retrieve and share, trade and/or transfer or otherwise use the digital media content compilations, or components thereof (“consumption attributes”);
(d) enabling users from one or more network connected devices to interact with or otherwise consume the digital media content compilations, such that the server computer enforces the one or more consumption attributes regardless of the users or groups of users, or network connected device(s) associated with such user or groups of users,
wherein each digital merchandise compilation constitutes a unique digital media object, where the actions of the users or group of users relative to the unique digital media object is defined by the consumption attributes.

11. The computer implemented method of claim 10, characterized in that the method comprises the further step of selecting and applying one or more rules for defining the manner in which the digital media content items relate to one another.

12. The computer implemented method of claim 10, characterized in that the method comprises the step of the administrative users defining scarcity attributes, and associating these with the digital media content compilation.

13. The computer implemented method of claim 10, characterized in that the method comprises the further step of selecting one or more attributes that result in changes to the consumption attributes (“change attributes”) based on one or more user interactions tracked by the server computer and linked by the server computer with the digital media content compilation.

14. The computer implemented method of claim 13, characterized in that the change attributes include one or more of:
(a) the number of trades or games authorized for the digital media content compilation;
(b) the transferability of the digital media content compilation and associated rules;
(c) scarcity rules for the digital media content compilation; and
(d) use of the digital media content compilation in connection with one or more network-connected games

15. The computer implemented method of claim 1, characterized in that the method comprises the step of using the server computer to define a collection of attributes that assign digital provenance with the digital media content compilation.
